(19) United States
(12) Patent Application Publication
(10) Pub. No.: US 2002/0010609 A1
(43) Pub. Date: Jan. 24, 2002

(54) Schedule managing system

(75) Inventor: Kenichi Niwa, Komaki-shi (JP)

Correspondence Address: OLIFF & BERRIDGE, PLC, P.O. BOX 19928, ALEXANDRIA, VA, 22320, US

(73) Assignee: COLIN CORPORATION

(21) Appl. No.: 09/822,424

(22) Filed: Apr. 2, 2001

(30) Foreign Application Priority Data
Jul. 24, 2000 (JP) 2000-221747

(51) Int. Cl. G06F 17/60

(52) U.S. Cl. 705/8

(57) ABSTRACT

A system for managing schedule data representing a common schedule including appointments according to which competitors and a manager cooperate with each other to perform respective cooperative actions, the system including competitor-side monitor devices which are operable by the competitors to propose respective appointments with the manager and each of which monitors the schedule data, a manager-side monitor device which is connected to each of the competitor-side monitor devices, which monitors the respective appointments proposed by the competitors and which is operable by the manager to accept each one of the appointments proposed by the competitors, a memory device which stores, as the schedule data, a first appointment proposed by a first competitor, together with first identification data identifying the first competitor and including a name of the first competitor, and stores a second appointment proposed by a second competitor, together with second identification data identifying the second competitor and including a name of the second competitor, and a modifying device for modifying the schedule data into first modified schedule data which represents a first modified common schedule which is to be monitored by the first competitor and does not include the name of the second competitor, and modifying the schedule data into second modified schedule data which represents a second modified common schedule which is to be monitored by the second competitor and does not include the name of the first competitor.

### BACKGROUND OF THE INVENTION

1. Field of the Invention

The present invention relates to a schedule managing system which manages a common schedule according to which a plurality of competitors and a manager who manages the competitors cooperate with each other to perform respective cooperative actions.

2. Related Art Statement

Japanese Patent Application laid open under Publication No. 2000-90165A discloses a schedule managing system which manages, by using an internet and portable terminals, a schedule which should naturally be managed by only a single person such as a manager but, in fact, is open to, e.g., a plurality of registered persons and the manager who needs to make respective appointments with the registered persons. In this system, each of the portable terminals of the registered persons is provided with a data transmitting means which automatically transmits, in response to a request signal received from the manager via the internet, a set of free-time data indicating a free time of the each designated person. Thus, the manager can judge, based on the sets of free-time data received from the portable terminals, whether the registered persons can perform their cooperative action, such as attending a meeting, and accordingly the manager can easily make the schedule.

Thus, the above-mentioned schedule managing system enables the manager to easily manage the schedule about the cooperative action which needs the attendance of the registered persons. However, the Japanese patent document does not disclose a technique which enables each of the registered persons to make his or her schedule about a cooperative action which needs the attendance of the manager, or fails to recognize such a problem to be solved. For example, in the case where a company supplies goods to each of a plurality of agencies to commission selling the goods, to the each agency, a manager of the company needs to cooperate with an agent of the each agency to explain the details of goods, to an end user or users. In this case, it is cumbersome for the respective agents of the agencies to make respective appointments with the manager so as to be able to perform respective cooperative actions. In addition, if the schedule of the manager would be open to the agents or the agencies, each one of the agents would notice the tendency of action of the other agent or agents, e.g., the name of an end user to which the other agent plans to explain the details of goods. In this case, each one of the competitive agents would be allowed to know the business secrets of the other agent or agents.

### SUMMARY OF THE INVENTION

It is therefore an object of the present invention to provide a schedule managing system which can easily manage a common schedule according to which a plurality of competitors and a manager who manages the competitors cooperate with each other to perform respective cooperative actions, without causing each one of the competitors to know the cooperative action or actions of the other competitor or competitors.

The above object has been achieved by the present invention. According to a first feature of the present invention, there is provided a system for managing schedule data representing a common schedule including a plurality of appointments according to which a plurality of competitors and a manager who manages the competitors cooperate with each other to perform respective cooperative actions, the system comprising: a plurality of competitor-side monitor devices which are operable by the plurality of competitors, respectively, to propose respective appointments with the manager, and each of which monitors the schedule data; a manager-side monitor device which is connected to the each of the competitor-side monitor devices via a communication line, which monitors the respective appointments proposed by the competitors through the respective competitor-side monitor devices, and which is operable by the manager to accept each one of the appointments proposed by the competitors; a memory device which stores, as the schedule data, a first appointment proposed by a first one of the competitors through a first one of the competitor-side monitor devices, together with first identification data identifying the first competitor and including at least a name of the first competitor, and stores, as the schedule data, a second appointment proposed by a second one of the competitors through a second one of the competitor-side monitor devices, together with second identification data identifying the second competitor and including at least a name of the second competitor; and a schedule-data modifying means for modifying the schedule data into first modified schedule data which is to be monitored by the first competitor-side monitor device and which represents a first modified common schedule which does not include the name of the second competitor, and modifying the schedule data into second modified schedule data which is to be monitored by the second competitor-side monitor device and which represents a second modified common schedule which does not include the name of the first competitor.

In the present schedule managing system, the memory-control means stores the proposed appointment received from each one of the competitor-side monitor devices, together with the identification data identifying the each one competitor-side monitor device or the corresponding competitor, as part of the schedule data representing the common schedule according to which the competitors and the manager cooperate with each other to perform respective cooperative actions, and the schedule-data modifying means modifies the schedule data into modified schedule data so that the each one competitor-side monitor device monitors the modified schedule data representing a modified common schedule which does not include at least the name or names of the other competitor or competitors. Thus, the present system does not allow each one of the competitors to know the business action or actions of the other competitor or competitors, and enables the each one competitor to easily make an appointment with the manager who manages the competitors and thereby perform a cooperative action of the each one competitor and the manager.

According to a second feature of the present invention, the schedule-data modifying means comprises means for modifying the schedule data into the first modified schedule data representing the first modified common schedule which does not include the name of the second competitor and at least one of a kind of the cooperative action of the second competitor and the manager, an aim of the cooperative action, and a place where the cooperative action is performed by the second competitor and the manager, and modifying the schedule data into the second modified schedule data representing the second modified common schedule which does not include the name of the first competitor and at least one of a kind of the cooperative action of the first competitor and the manager, an aim of the cooperative action, and a place where the cooperative action is performed by the first competitor and the manager. In this case, the schedule managing system can more effectively prevent each one of the competitors from knowing the business action or actions of the other competitor or competitors.

According to a third feature of the present invention, the schedule managing system further comprises an altering means for altering, when the manager operates the manager-side monitor device to accept the first appointment proposed by the first competitor, the schedule data including the first appointment proposed by the first competitor, to the altered schedule data including the first appointment accepted by the manager, and altering, when the manager operates the manager-side monitor device to accept the second appointment proposed by the second competitor, the schedule data including the second appointment proposed by the second competitor, to the altered schedule data including the second appointment accepted by the manager. In this case, the altering means alters, when the manager operates the manager-side computer to accept the proposed appointment stored as part of the schedule data by the memory device, the schedule data into the altered schedule data including the accepted appointment. Thus, the competitor who has transmitted the proposed appointment to the manager can immediately check whether his or her proposed appointment has been accepted by the manager.

According to a fourth feature of the present invention, the manager-side monitor device comprises a display device which displays, based on the schedule data, the common schedule including at least one of the first appointment proposed by the first competitor and the first appointment accepted by the manager, the name of the first competitor, at least one of the second appointment proposed by the second competitor and the second appointment accepted by the manager, and the name of the second competitor; the first competitor-side monitor device comprises a display device which displays, based on the first modified schedule data, the common schedule including a date and a time of at least one of the second appointment proposed by the second competitor and the second appointment accepted by the manager; and the second competitor-side monitor device comprises a display device which displays, based on the second modified schedule data, the common schedule including a date and a time of at least one of the first appointment proposed by the first competitor and the first appointment accepted by the manager. In this case, each one of the competitors can monitor the common schedule including one or more proposed appointments input by the other competitors and/or one or more accepted appointments input by the manager, without knowing the respective names of the other competitors. Therefore, the each one competitor can input his or her proposed appointment such that the proposed appointment does not collide or conflict, on the time-table of the common schedule, with the proposed or accepted appointments of the other competitors and accordingly would be able to obtain the manager's final acceptance of his or her proposed appointment.

### BRIEF DESCRIPTION OF THE DRAWINGS

The above and optional objects, features, and advantages of the present invention will be better understood by reading the following detailed description of preferred embodiments of the invention when considered in conjunction with the accompanying drawings, in which:

FIG. 1 is an illustrative view for explaining a general construction of a schedule managing system which includes a plurality of competitor-side computers and a manager-side computer which can communicate with each of the competitor-side computers, and to which the present invention is applied;

FIG. 2 is a block diagram for explaining essential functions of each of the competitor-side computers, and the manager-side computer;

FIG. 3 is a view for explaining respective original or modified common schedules which are displayed by respective display devices of the competitor-side computers and the manager-side computer;

FIG. 4 is a flow chart representing a first control program according to which each of the competitor-side computers is operated; and

FIG. 5 is a flow chart representing a second control program according to which the manager-side computer is operated.

### DETAILED DESCRIPTION OF PREFERRED EMBODIMENTS

Hereinafter, there will be described in detail a schedule managing system 8 embodying the present invention, by reference to the drawings.

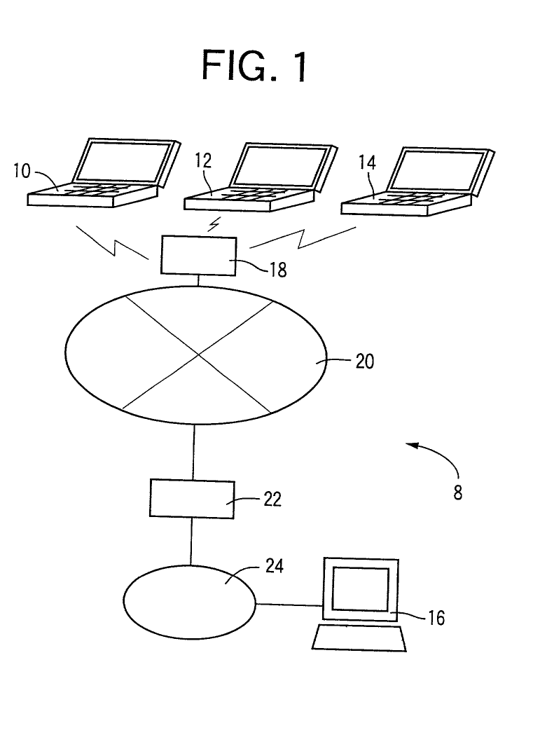

FIG. 1 shows a general construction of the schedule managing system 8. The present system 8 includes a plurality of personal computers 10, 12, 14 which are respectively operated by a plurality of natural or legal persons, A, B, and C, such as agents or promoters, or agencies. In addition, the present system 8 includes a personal computer 16 which is operated by a natural or legal person, AT, such as a manager or staff of sales administration department, or a sales company, who supplies goods to each of the agencies A, B, C to commission selling the goods, to the each agency A, B, C. The computer 16 is connected to each of the computers 10, 12, 14 via an exchange 18, a communication network 20 such as a public telephone network, a provider 22, and an in-house local area network (LAN) 24, so that the computer 16 can communicate with the each computer 10, 12, 14, as needed.

The three computers 10, 12, 14 are operated by the three agents A, B, C who are competitive to one another to request or propose respective appointments with the manager AT, and function as three competitor-side monitor devices each of which monitors a schedule data representing a common schedule according to which each of the agents A, B, C cooperates with the manager AT to perform a cooperative action. The computer 16 functions as a manager-side monitor device which monitors the respective appointments proposed by the agents A, B, C and which is operated by the manager AT who manages the agents A, B, C, to finally accept each of the appointments proposed by the agents A, B, C. Thus, the schedule managing system 8 including the computers 10, 12, 14, 16 connected to one another, manages the common schedule accordingly to which each of the competitive agents A, B, C cooperates with the manager AT who manages the respective cooperative actions with the agents A, B, C, to perform a corresponding one of the respective cooperative actions.

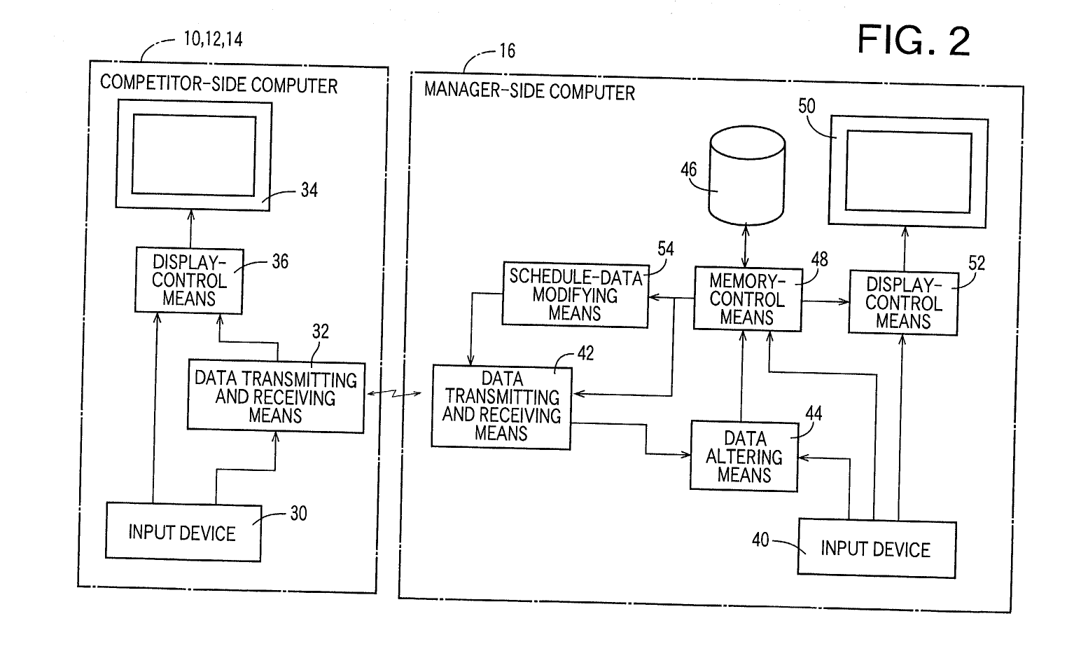

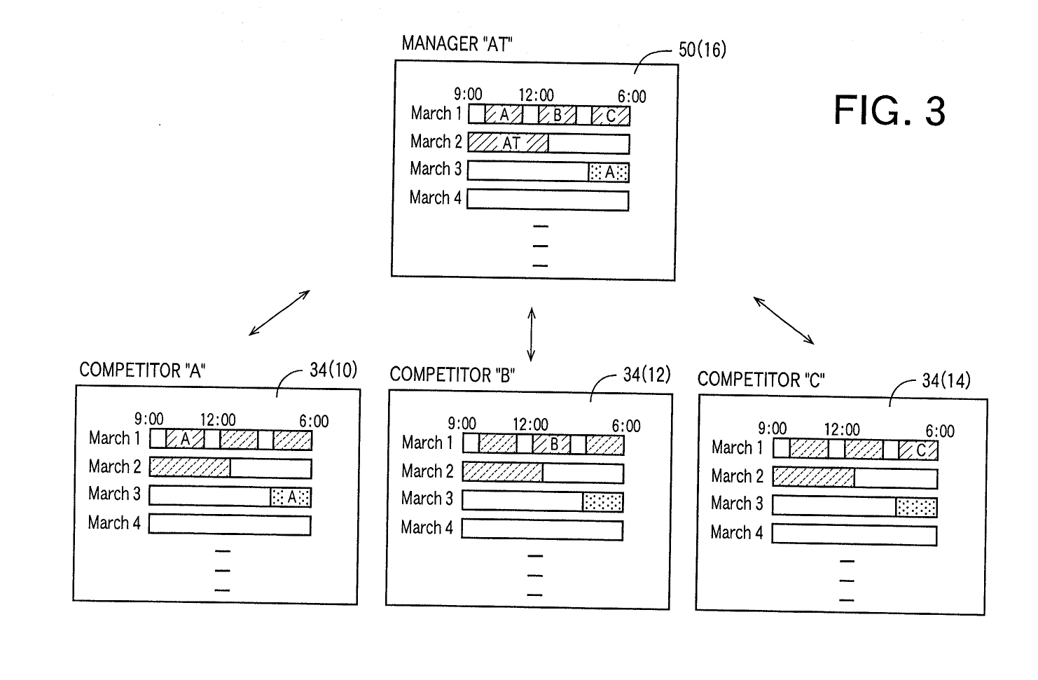

FIG. 2 is a block diagram for explaining essential functions of the computers 10, 12, 14 and the computer 16. In FIG. 2, each of the computers 10, 12, 14 includes an input device 30 including a keyboard which is manually operable by a corresponding one of the agents A, B, C, to input a proposal of an appointment with the manger AT, or other sorts of data; a data transmitting and receiving means 32 which receives the schedule data supplied from the manager-side computer 16; a display device 34 such as a liquid crystal display (LCD); and a display-control means 36 which controls the display device 34 to display, based on the schedule data, the common schedule. The data transmitting and receiving means 32 transmits, to the manager-side computer 16, proposed-appointment data indicating the proposed appointment input through the input device 30, together with identification data identifying the each computer 10, 12, or 14, or the one agent A, B, or C, and receives, from the manager-side computer 16, the schedule data additionally including the proposed-appointment data which had been transmitted thereby to the manager-side computer 16. The display-control means 36 controls the display device 34 to display, based on the schedule data additionally including the proposed-appointment data, the common schedule additionally including the proposed appointment which has been input by the one agent A, B, or C, as shown in FIG. 3.

The manager-side computer 16 includes an input device 40 including a keyboard which is manually operable by the manager AT to input his or her own scheduled plans or items, or final-acceptance data indicating that the manager AT has finally accepted each one of the appointments proposed by the competitive agents A, B, C. The computer 16 additionally includes a data transmitting and receiving means 42 which receives the proposed-appointment data transmitted by each of the competitor-side computers 10, 12, 14; a data altering means 44 which alters, when the manager AT inputs the final-acceptance data through the input device 40, the proposed-appointment data to accepted-appointment data indicating that the proposed appointment has been finally accepted by the manager AT; a memory device 46; a memory-control means 48 which controls the memory device 46 to record or store the schedule data additionally including the accepted-appointment data; a display device 50; a display-control device 52 which controls the display device 50 to display, based on the schedule data additionally including the accepted-appointment data, the common schedule additionally including the accepted-appointment, as shown in FIG. 3; and a schedule-data modifying means 54 which modifies, before the data transmitting and receiving means 42 transmits the schedule data stored in the memory device 46, to each one of the competitor-side computers 10, 12, 14, the schedule data into modified schedule data suitable for the each one computer 10, 12, 14. The data altering means 44 alters, via the memory-control means 48, the schedule data stored in the memory device 46, in such a manner that when the data transmitting and receiving means 42 receives a set of proposed-appointment data from each one of the competitor-side computers 10, 12, 14, the schedule data is updated to include the set of proposed-appointment data, that, when the manager AT inputs a set of final-acceptance data for the set of proposed-appointment data, the proposed-appointment data is altered to a set of accepted-appointment data and the schedule data is updated to include the set of accepted-appointment data, and that when the manager AT inputs his or her own scheduled items, the schedule data is updated to include the manager's own scheduled items.

The memory-control means 48 records or stores, as a portion of the schedule data stored in the memory device 46, a set of proposed-appointment data transmitted from each one of the competitor-side computers 10, 12, 14, e.g., a first computer 10, together with a set of identification data identifying the each one computer 10, 12, 14, e.g., the first computer 10. As shown in FIG. 3, the display-control means 52 of the manager-side computer 16 controls the display device 50 to display the common schedule represented by the schedule data stored in the memory device 46, in such a manner that the common schedule includes a proposed appointment at a date and a time which are represented by the set of proposed-appointment data newly added to the schedule data and are indicated by dot pattern and with a registered name of the corresponding one competitor, e.g., a registered name, “A”, of the first competitor A who operates the first computer 10. The respective names of the competitors A, B, C are registered, in advance, in the memory device 46 of the manager-side computer 16, through operation of the input device 40, in such a manner that the respective names of the competitors A, B, C are associated with the respective sets of identification data identifying the competitors A, B, C.

Each one of the agents or competitors A, B, C uses the display device 34 of a corresponding one of the competitor-side computers 10, 12, 14, to monitor the common schedule so as to propose his or her appointment with the manager AT or check if his or her proposed appointment has been finally accepted by the manager AT. For example, the first agent A uses the display device 34 of the first computer 10. In this case, the schedule-data modifying means 54 modifies the original schedule data read out by the memory-control means 48 from the memory device 46, into first modified schedule data which does not include any sets of identification data identifying the other agents B, C than the first agent A, and the data transmitting and receiving means 42 transmits the first modified schedule data to the first computer 10, so that the display device 34 of the first computer 10 displays, based on the first modified schedule data, a first modified common schedule which includes, in relation with each of the proposed or accepted appointments of the other agents B, C, a date and a time of the each appointment only. Each set of identification data may include a name of an agent or competitor, a kind or sort of a cooperative action of an agent and the manager, an aim of the cooperative action, and/or a place where the cooperative action is performed by the agent and the manager, and essentially includes at least the name of each agent A, B, C.

Thus, in the above-indicated case, the display device 34 of the first competitor-side computer 10 is controlled by the display-control means 36, and the display device 50 of the manager-side computer 16 is controlled by the display-control means 52, each so as to display a proposed appointment input by the first computer 10, or an accepted appointment altered from the proposed appointment by the altering means 44, each including a registered name “A” of the first competitor A, as shown in FIG. 3. On the other hand, the display device 34 of each of the second and third competitor-side computers 12, 14 other than the first computer 10 is controlled by the display-control means 36, so as to display, according to second or third modified schedule data transmitted from the manager-side computer 16, a date and a time of the proposed or accepted appointment only, without displaying the registered name “A” of the first competitor A, as shown in FIG. 3. In this figure, straight-line hatching indicates an accepted appointment displayed with its identification data (e.g., registered competitor's name); broken-line hatching indicates an accepted appointment displayed without its identification data; and dot pattern indicates a proposed appointment.

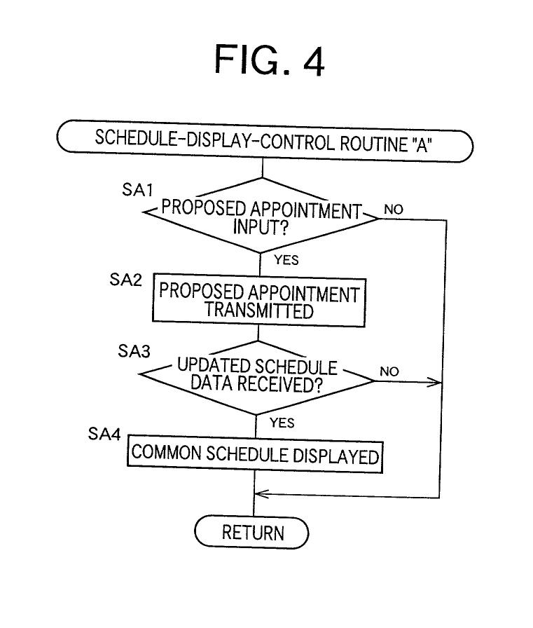

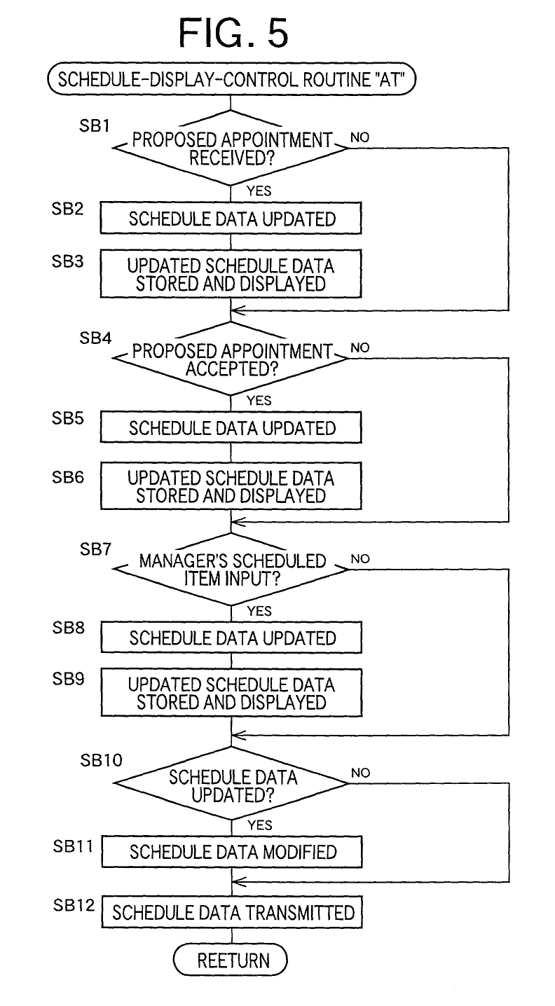

FIG. 4 is a flow chart representing a control program which is stored in a read only memory (ROM), not shown, of each one of the competitor-side computers 10, 12, 14 and according to which each one computer 10, 11, 14 is likewise operated; and FIG. 5 is a flow chart representing a control program which is stored in a ROM, not shown, of the manager-side computer 16 and according to which the computer 16 is operated.

Since the three computers 10, 12, 14 are likewise operated according to the control program, i.e., schedule-display-control routine, the following description relates to the case where the first computer 10 is operated by the first agent or competitor A. In FIG. 4, at Step SA1, the computer 10 judges whether the competitor A has operated the input device 30 to input his or her proposed appointment with the manager AT. If a negative judgment is made at Step SA1, the current control cycle according to this routine is ended. On the other hand, if a positive judgment is made at Step SA1, the control proceeds with Step SA2 corresponding to the data transmitting and receiving means 32, where the computer 10 transmits the input proposed appointment to the manager-side computer 16. Step SA2 is followed by Step SA3 where the computer 10 judges whether the computer 10 has received updated schedule data from the manager-side computer 16, which updates the schedule data representing the common schedule when the computer 16 receives a proposed appointment from each competitor-side computer 10, 12, 14, the manager AT operates the computer 16 to accept a proposed appointment, or the manager AT operates the computer 16 to input his or her own scheduled item, at Step SB2, SB5, or SB8 of FIG. 5. If a negative judgment is made at Step SA3, the current control cycle according to this routine is ended. On the other hand, if a positive judgment is made at Step SA3, the control proceeds with Step SA4 corresponding to the display-control means 36, where the computer 10 operates the display device 34 to display, based on the updated schedule data, the common schedule according to which the first competitor A and the manager cooperate with each other to perform their cooperative action or actions. If the proposed appointment input by the first competitor A at Step SA1 has not been accepted by the manager AT, the proposed appointment is indicated at dot pattern with the registered name “A” of the competitor A, as illustrated in FIG. 3; and if the proposed appointment has been accepted by the manager AT, the accepted appointment is indicated at straight-line hatching with the registered name “A” of the competitor A, as illustrated in FIG. 3. However, the common schedule displayed by the display device 34 of the second or third competitor-side computer 12, 14 includes only a date and a time the proposed or accepted appointment of the first competitor A, and does not include the registered name “A” of the competitor A.

At Step SB1 of FIG. 5, the manager-side computer 16 judges whether the computer 16 has received a proposed appointment from any one of the three competitor-side computers 10, 12, 14. If a negative judgment is made at Step SB1, the control proceeds with Step SB4 and the following steps. On the other hand, if a positive judgment is made at Step SB1, the control proceeds with Step SB2 corresponding to the data altering means 44, where the computer 16 alters or updates the schedule data stored in the memory device 46, into altered or updated schedule data including the proposed appointment received at Step SB1 and the identification data received with the proposed appointment at Step SB1. Step SB2 is followed by Steps SB3 corresponding to the memory-control means 48 and the display-control means 52, where the computer 16 stores, in the memory device 46, the updated schedule data including the proposed appointment and the identification data, and displays, on the display device 50, the common schedule, as shown in FIG. 3.

Then, at Step SB4, the computer 16 judges whether the manager AT has operated the input device 40 to input appointment-acceptance data to accept the proposed appointment received at Step SB1. If a negative judgment is made at Step SB4, the control goes to Step SB7 and the following steps. On the other hand, if a positive judgment is made at Step SB4, the control goes to Step SB5 corresponding to the data altering means 44, where the computer 16 alters or updates the schedule data including the proposed appointment, stored in the memory device 46, to altered or updated schedule data including the accepted appointment. Then, the control goes to Step SB6 corresponding to the memory-control means 48 and the display-control means 52, where the computer 16 stores, in the memory device 46, the updated schedule data including the accepted appointment and the identification data, and displays, on the display device 50, the common schedule, as shown in FIG. 3.

Then, at Step SB7, the computer 16 judges whether the manager AT has operated the input device 40 to input his or her own scheduled item. If a negative judgment is made at Step SB7, the control goes to Step SB10 and the following steps. On the other hand, if a positive judgment is made at Step SB7, the control goes to Step SB8 corresponding to the data altering means 44, where the computer 16 alters or updates the schedule data, stored in the memory device 46, to altered or updated schedule data including the manager's own scheduled item input at Step SB7 and identification data identifying the manager AT (e.g., a registered name “AT” of the manager AT). Then, the control goes to Step SB9 corresponding to the memory-control means 48 and the display-control means 52, where the computer 16 stores, in the memory device 46, the updated schedule data including the manager's own scheduled item, and displays, on the display device 50, the common schedule, as shown in FIG. 3.

Then, at Step SB10, the computer 16 judges whether the schedule data have been altered or updated. If a positive judgment is made at Step SB10, the control goes to Step SB11 corresponding to the schedule-data modifying means 54, where the manager-side computer 16 modifies, before it transmits the schedule data stored in the memory device 46, to each one of the competitor-side computers 10, 12, 14, the schedule data into modified schedule data suitable for the each one competitor-side computers 10, 12, 14. For example, before the manager-side computer 16 transmits the schedule data read out by the memory-control means 48, to the first competitor-side computer 10 of the first competitor A, so that the common schedule is displayed by the display device 34 of the same 10, the computer 16 modifies the schedule data into first modified schedule data representing a first modified common schedule which include, for the other competitors B, C than the competitor A, only a date and a time of each of the proposed or accepted appointments of those competitors B, C and do not include any sets of identification data of the same B, C. Likewise, the computer 16 modifies the schedule data into second modified schedule data for the second competitor B, and third modified schedule data for the third competitor C. Step SB11 is followed by Step SB 12 where the manager-side computer 16 transmits the first, second, and third modified schedule data to the first, second, and third competitor-side computers 10, 12, 14, respectively. On the other hand, if a negative judgment is made at Step SB10, the control directly goes to Step SB12, because the schedule data have not been updated and accordingly need not be modified.

As is apparent from the foregoing description, in the present embodiment, the memory-control means 48 (Step SB3) stores, in the memory device 46, the proposed appointment received from each one of the competitor-side computers (i.e., competitor-side monitor devices) 10, 12, 14, e.g., the first computer 10, together with the identification data identifying the first computer 10 or the first competitor A, as part of the schedule data representing the common schedule according to which the competitors A, B, C and the manager AT cooperate with each other to perform respective cooperative actions; and the schedule-data modifying means 54 (Step SB11) modifies the schedule data into first modified schedule data suitable for the first competitor A, so that the first computer 10 monitors the first modified schedule data representing a first modified common schedule which does not include, for the cooperative actions of the manager AT and the other competitors B, C than the competitor A, at least the respective registered names “B”,“C” of the same B, C. Thus, the present system 8 does not allow each one of the competitors A, B, C to know the respective business actions of the other competitors, and enables the each one competitor A, B, C to easily make an appointment with the manager AT who manages all the competitors A, B, C and thereby perform a cooperative action of the each one competitor and the manager.

In addition, in the present embodiment, the schedule-data modifying means 54 (Step SB11) modifies the schedule data representing the common schedule, into the first modified schedule data suitable for the first competitor A, so that the first competitor-side computer 10 monitors the first modified schedule data representing the first modified common schedule which does not include, for the cooperative actions of the manager AT and the other competitors B, C than the competitor A, at least one of a kind of each of those cooperative actions, an am of the each action, and a place where the each action is performed. Thus, the present system 8 more effectively prevents each one of the competitors A, B, C from knowing the respective business actions of the other competitors.

In addition, in the present embodiment, the data altering means 44 (Step SB5) alters, when the manager AT operates the manager-side computer 16 to finally accept the proposed appointment stored as part of the schedule data by the memory-control means 48 (Step SB3), the schedule data into altered schedule data including the thus accepted appointment. Thus, the competitor who has transmitted the proposed appointment to the manager can immediately check whether his or her proposed appointment has been accepted by the manager.

In addition, in the present embodiment, the display-control means 52 (Step SB3) of the manager-side computer 16 operates the display device 50 to display the common schedule including a proposed appointment received from each one of the competitor-side computers 10, 12, 14, e.g., the first competitor-side computer 10, or an accepted appointment altered from the proposed appointment by the data altering means 44, together with identification data identifying the first competitor-side computer 10 or the first competitor A; the display-control means 36 (Step SA4) of the first competitor-side computer 10 operates the display device 34 to display the first modified common schedule including a proposed appointment transmitted thereby to the manager-side computer 16, or an accepted appointment altered from the proposed appointment by the data altering means 44, together with identification data identifying the first competitor-side computer 10 or the first competitor A; and the display-control means 36 (Step SA4) of each of the other competitor-side computers 12, 14 than the first computer 10 operates the display device 34 thereof to display, based on corresponding modified schedule data provided by the schedule modifying means 54, a corresponding modified common schedule which includes, for a proposed or accepted appointment of the first competitor A, only a date and a time of the proposed or accepted appointment and does not include at least the registered name “A” of the first competitor A. Thus, the first competitor A can monitor the common schedule including one or more proposed appointments input by the other competitors B, C and/or one or more accepted appointments input by the manager AT, without knowing the respective names of those competitors B, C. Therefore, the first competitor A can input his or her proposed appointment such that the proposed appointment does not collide or conflict, on the time-table of the common schedule, with the proposed or accepted appointments of the other competitors B, C, and accordingly would be able to obtain the manager's final acceptance of his or her proposed appointment.

While the present invention has been described in its preferred embodiment by reference to the drawings, it is to be understood that the invention may otherwise be embodied.

For example, in the illustrated embodiment, the manager-side computer 16 transmits, in each of respective control cycles according to the control routine of FIG. 5, the schedule data to each of the competitor-side computers 10, 12, 14. However, it is possible to modify the manager-side computer 16 such that the computer 16 transmits the schedule data to each of the competitor-side computers 10, 12, 14, at predetermined regular intervals of time, or in response to a request supplied from each computer 10, 12, 14.

In addition, in the illustrated embodiment, each of the competitor-side computers 10, 12, 14 and the manager-side computer 16 displays the common schedule in the form of a plurality of bar graphs each of which represent a day. However, it is possible to modify each computer 10, 12, 14, 16 to display a common schedule in the form of a list of respective dates and times of proposed or accepted appointments that are expressed in numerals.

In addition, in the illustrated embodiment, the memory device 46, the memory-control means 48, the data altering means 44, and the schedule-data modifying means 54 are employed in the manager-side computer 16. However, it is possible that one or more of the above device and means 46, 48, 44, 54 be employed in a host computer which is accessible by each of the competitor-side computers 10, 12, 14 and the manager-side computer 16.

It is to be understood that the present invention may be embodied with other changes, improvements and modifications that may occur to one skilled in the art without departing from the spirit and scope of the invention.

What is claimed is:

1. A system for managing schedule data representing a common schedule including a plurality of appointments according to which a plurality of competitors and a manager who manages the competitors cooperate with each other to perform respective cooperative actions, the system comprising:
a plurality of competitor-side monitor devices which are operable by the plurality of competitors, respectively, to propose respective appointments with the manager, and each of which monitors the schedule data;
a manager-side monitor device which is connected to said each of the competitor-side monitor devices via a communication line, which monitors the respective appointments proposed by the competitors through the respective competitor-side monitor devices, and which is operable by the manager to accept each one of the appointments proposed by the competitors;
a memory device which stores, as the schedule data, a first appointment proposed by a first one of the competitors through a first one of the competitor-side monitor devices, together with first identification data identifying the first competitor and including at least a name of the first competitor, and stores, as the schedule data, a second appointment proposed by a second one of the competitors through a second one of the competitor-side monitor devices, together with second identification data identifying the second competitor and including at least a name of the second competitor; and
a schedule-data modifying means for modifying the schedule data into first modified schedule data which is to be monitored by the first competitor-side monitor device and which represents a first modified common schedule which does not include the name of the second competitor, and modifying the schedule data into second modified schedule data which is to be monitored by the second competitor-side monitor device and which represents a second modified common schedule which does not include the name of the first competitor.

2. A system according to claim 1, wherein the schedule-data modifying means comprises means for modifying the schedule data into the first modified schedule data representing the first modified common schedule which does not include the name of the second competitor and at least one of a kind of the cooperative action of the second competitor and the manager, an aim of the cooperative action, and a place where the cooperative action is performed by the second competitor and the manager, and modifying the schedule data into the second modified schedule data representing the second modified common schedule which does not include the name of the first competitor and at least one of a kind of the cooperative action of the first competitor and the manager, an aim of the cooperative action, and a place where the cooperative action is performed by the first competitor and the manager.

3. A system according to claim 1, further comprising an altering means for altering, when the manager operates the manager-side monitor device to accept the first appointment proposed by the first competitor, the schedule data including the first appointment proposed by the first competitor, to the altered schedule data including the first appointment accepted by the manager, and altering, when the manager operates the manager-side monitor device to accept the second appointment proposed by the second competitor, the schedule data including the second appointment proposed by the second competitor, to the altered schedule data including the second appointment accepted by the manager.

4. A system according to claim 3, wherein the manager-side monitor device comprises a display device which displays, based on the schedule data, the common schedule including at least one of the first appointment proposed by the first competitor and the first appointment accepted by the manager, the name of the first competitor, at least one of the second appointment proposed by the second competitor and the second appointment accepted by the manager, and the name of the second competitor; the first competitor-side monitor device comprises a display device which displays, based on the first modified schedule data, the common schedule including a date and a time of at least one of the second appointment proposed by the second competitor and the second appointment accepted by the manager; and the second competitor-side monitor device comprises a display device which displays, based on the second modified schedule data, the common schedule including a date and a time of at least one of the first appointment proposed by the first competitor and the first appointment accepted by the manager.

5. A system according to claim 1, wherein the manager-side monitor device comprises a display device which displays, based on the schedule data, the common schedule including a date and a time of the first appointment proposed by the first competitor and the name of the first competitor, and a date and a time of the second appointment proposed by the second competitor and the name of the second competitor; the first competitor-side monitor device comprises a display device which displays, based on the first modified schedule data, the common schedule including a date and a time of the first appointment proposed by the first competitor and the name of the first competitor, and a date and a time of the second appointment proposed by the second competitor; and the second competitor-side monitor device comprises a display device which displays, based on the second modified schedule data, the common schedule including a date and a time of the second appointment proposed by the second competitor and the name of the second competitor, and a date and a time of the first appointment proposed by the first competitor.

6. A system according to claim 1, wherein at least one of the competitor-side monitor devices and the manager-side monitor device comprises a personal computer.

7. A system according to claim 1, wherein the competitor-side monitor devices and the manager-side monitor device are connected to one another via the communication line comprising a telephone network.

8. A medium for recording a program such that the program is readable by a manager-side computer to manage schedule data representing a common schedule including a plurality of appointments according to which a plurality of competitors and a manager who manages the competitors cooperate with each other to perform respective cooperative actions, the program comprising the steps of
receiving, from a plurality of competitor-side computers to each of which the manager-side computer is connected via a communication line, respective appointments proposed by the plurality of competitors,
allowing the manager to accept each one of the appointments proposed by the competitors,
storing, as the schedule data, a first appointment proposed by a first one of the competitors through a first one of the competitor-side computers, together with first identification data identifying the first competitor, and a second appointment proposed by a second one of the competitors through a second one of the competitor-side computers, together with second identification data identifying the second competitor,
modifying the schedule data into first modified schedule data which is to be monitored by the first competitor-side computer and which does not include the second identification data, and into second modified schedule data which is to be monitored by the second competitor-side computer and which does not include the first identification data, and
transmitting the first modified schedule data to the first competitor-side computer, and transmitting the second modified schedule data to the second competitor-side computer.
